(19) United States
(12) Patent Application Publication
(10) Pub. No.: US 2019/0197543 A1
(43) Pub. Date: Jun. 27, 2019

(54) METHODS FOR AUTHENTICATING A USER, AUTHENTICATION DEVICES, AND COMPUTER READABLE MEDIA

(71) Applicant: Mastercard International Incorporated, Purchase, NY (US)

(72) Inventors: Sudhir Gupta, Pune (IN); Rahul Agrawal, Pune (IN)

(21) Appl. No.: 16/162,816

(22) Filed: Oct. 17, 2018

(30) Foreign Application Priority Data
Dec. 21, 2017 (SG) 10201710693P

(51) Int. Cl. G06Q 20/40; G06Q 20/38; G06F 21/31

(52) U.S. Cl. CPC G06Q 20/4014; G06F 21/316; G06Q 20/3821

(57) ABSTRACT

Methods and devices for authenticating a user are provided. The method for authenticating a user may include: providing a question to the user; receiving an answer to the question from the user; comparing the answer with a preference of the user; and authenticating the user based on the comparing. At least one of the question or the preference is determined based on at least one of circumstantial data of the user, a transaction data associated with the user, and feedback data from the user.

### CROSS-REFERENCE TO RELATED APPLICATION

This application is a U.S. National Stage filing under 35 U.S.C. § 119, based on and claiming benefits of and priority to Singapore Patent Application No. 10201710693P filed on Dec. 21, 2017. The entire disclosure of the above application is incorporated herein by reference for all purposes.

### FIELD OF INVENTION

The present invention relates broadly, but not exclusively, to methods for authenticating a user, authentication devices, and computer readable media.

### BACKGROUND

Secure authentication is crucial in many applications. For example, a person's identity may be validated using biometric authentication. However, existing biometric solution require huge infrastructure investment cost. On the other hand, PINs (personal identification numbers) are no longer secure, because PINs may be compromised very commonly.

A need therefore exists to provide devices and methods to address the above problem, for example to identify a person using current infrastructure.

### SUMMARY

According to various embodiments, a method for authenticating a user may be provided. The method may include: providing a question to the user; receiving an answer to the question from the user; comparing the answer with a preference of the user; and authenticating the user based on the comparing; wherein at least one of the question and the preference is determined based on at least one of circumstantial data of the user, transaction data associated with the user, and feedback data from the user.

According to various embodiments, an authentication device may be provided. The authentication device may include: a question provider circuit configured to provide a question to a user based on at least one of circumstantial data of the user, transaction data associated with the user, and feedback data from the user; a receiver configured to receive an answer to the question from the user; a comparison circuit configured to compare the answer with a preference of the user; and an authentication circuit configured to authenticate the user based on the comparing; wherein the preference is selected, based on the circumstantial data of the user, from one or more stored preferences associated with the user.

According to various embodiments, a computer readable medium may be provided. The computer readable medium may include instructions which, when executed by a processor, make the processor perform a method for authenticating a user. The method may include: providing a question to the user; receiving an answer to the question from the user; comparing the answer with a preference of the user; and authenticating the user based on the comparing; wherein at least one of the question and the preference is determined based on at least one of circumstantial data of the user, transaction associated with the user, and feedback data from the user.

### BRIEF DESCRIPTION OF THE DRAWINGS

Embodiments and implementations are provided by way of example only, and will be better understood and readily apparent to one of ordinary skill in the art from the following written description, read in conjunction with the drawings, in which:

FIG. 1A shows a flow diagram illustrating a method for authenticating a user according to various embodiments;

FIG. 1B shows an authentication device according to various embodiments;

FIG. 1C shows an authentication device according to various embodiments;

FIG. 2 shows an illustration 200 of possible questions, wherein a user may be asked to arrange the things shown based on the user's preference.

FIG. 3 shows a flow diagram illustrating a dataflow for user registration, when a user is directly registered for this service with a server according to various embodiments;

FIG. 4 shows a flow diagram illustrating dataflow to create a user preference database, when the user is directly registered for this service according to various embodiments;

FIG. 5 shows a flow diagram illustrating a dataflow to verify a user preference database, when the user is directly registered for this service according to various embodiments;

FIG. 6 shows a flow diagram illustrating dataflow between the server and an online shopping portal according to various embodiments;

FIG. 7 shows a flow diagram illustrating a dataflow for user registration, when a member bank registers its user for behavior password service according to various embodiments;

FIG. 8 shows a flow diagram illustrating a dataflow to create a user preference database, when a user's Issuer is registered for behavior password service according to various embodiments;

FIG. 9 shows a flow diagram illustrating a dataflow between the server and the member bank, when the user Cs issuer is registered for behavior password service according to various embodiments; and

FIG. 10 depicts an exemplary computing device according to various embodiments.

### DETAILED DESCRIPTION

### Overview

Various embodiments provide a behavioral password for extra security.

According to various embodiments, a password related to a preference of the user may be used. The preference may be determined based on at least one of a circumstance under which the method is performed, a recent transaction performed by the user, or a recent feedback from the user.

Each person may have their own preferences and those preferences don't generally change in short time period. Even if some preferences get changed, it is not possible (or at least very unlikely) that all preferences change at a time.

Preferences can relate to different categories, such as places, foods, sports, cultures, politics, etc. For example, if people are asked to arrange the following cities in order of preference: A—London; B—New York; and C—Mumbai, one person may prefer New York over Mumbai and London, while another person may choose Mumbai over London and New York. This is based on individual preferences. People do not need to (actively) remember such preferences, because people got these preferences over the years of experiences or choices. These preferences also identify the person's behavior.

According to various embodiments, a database of individual person's preferences may be built based on a selected category (for example vehicles, sports, or geography). When the person goes to any ATM (automatic teller machine) or does any online transactions, a system according to various embodiments may ask the person to set the preferences of one or more pre-determined questions. This may help to generate the database of the individual preferences.

Once the system according to various embodiments (for example payment system) has sufficient data in the database (for example the answers to 100 to 500 questions), it may ask the person to set the following things: a—Do you want to set the behavioral password? b—If Yes, enter the high volume transaction value on which you want to enable this extra security feature.

Each person may select their own high value transaction (HVT) value. For example, 5000 INR withdrawal or payment is a HVT for someone.

Once the user opts for behavior password, the next time when the user does any high volume transaction, the system may ask the user one or more questions from the database to mark the preferences in order after entering valid PIN.

For example, the system may randomly ask 4 questions, each question having four options. (i.e. give as a permutation and combination [ⁿcᵣ]⁴c₄). If the person enters all the 16 options in correct order, he/she is the authentic user.

Generally, preferences are something that nobody needs to (actively) remember, because they automatically have been established over the years of experiences and choices. However, preferences may change over the time.

For example, if a person entered any wrong preferences for any one question, the system according to various embodiments may again ask the person four or one or more random questions (which may be new questions) to set the preferences. If the person enters the correct preferences for the new set of questions, this may mean that his/her preferences got changed. The system may then record the new preference for the question and may store it in the database for the next time. This may help to keep the preferences in sync with individual persons, even if preferences keep changing over the time.

Usually, user preferences don't change for a short duration of time but there are factors that may influence the user's preferences, for example, location, time, climate, or weather. Hence, multiple preference orders may exist for the same question based on such factors.

For example, with respect to location, in India, a user may prefer dominos or pizza hut over subway, but when the user is in the USA, the user may prefer subway over pizza hut or dominos (for example because the user is vegetarian).

For example, with respect to time, before moving to Pune, a user may like Mumbai more than any other city, but over time, after moving to Pune, the user may start liking Pune over Mumbai. As such, the user's preferences may get changed over time.

For example, with respect to weather, a user may prefer car over bike for transportation or cold drinks over coffee/tea in summer, and his preferences may be different in winter.

According to various embodiments, to make behavior password secure and up to date, new questions may be added, and the existing preferences may be updated, as they may change over the time. The user may not need to (actively) remember the preferences that he/she set at the time of answering those questions.

For example, if a user answered 80% answers right and 20% answers wrong (i.e. not matching with old answers), there are strong chances that the user's preferences got changed for those questions over the time or location.

According to various embodiments, instead of asking random questions to know more about user preferences, the system may use the user's past transactions (for example credit card transactions or bank account transactions) to know more about the user preferred category. So there may be high chances that a user may answer or remember those questions more correctly than a random question.

For example, if a user has spent more money on sport items and food, it might be that the user's preferred category is sports and food.

According to various embodiments, instead of asking preferences from the user, the preferences may be generated by analyzing the user's latest activity (for example credit card activity, or bank account activity, or activity on social media, or activity in reviewing of online shop portals). Alternatively or in addition, data from a user device may be obtained to determine e.g. the location of the user, time and weather at the location.

For example, if last month, a user has purchased a mobile phone from an online shop, and recently, the user provided his positive feedback about the gaming experience with this mobile phone on that website, this feedback may be obtained by scanning the website for comments by a username or screen name associated with the user and may be used to know about the user preferences about that product and verify it without asking this answer from user. For example, the user may be asked: are you happy with the gaming experience of your recently purchased phone? And the user may be offered the following answers: “Yes”; “No”; “Maybe”; and “Not sure”.

In another non-limiting example, if the user is in the United States and is asked to arrange a list of restaurants then the order may be Pizza Hut—McDonalds—Subway—Burger King. If the user is in India and is asked to arrange same list then the order may be McDonalds—Subway—Pizza Hut—Burger King. In other words, multiple preferences may exist for the same user based on his location. The preference of the user may differ based on the location and so does the behavioral password. The present method and system can obtain location data from user device and provide such data as a parameter to the algorithm so that the correct preference can be fetched to check the answer provided by the user to a password question. For example, if the user is using a mobile phone, the location data of the user can be obtained from the Global Positioning System (GPS) data associated with the mobile phone.

In yet another non-limiting example, if the user has consistently been spending on books from different bookstores using a payment card, including physical stores, blog shops, as well as online stores like Amazon and Barnes & Noble, the transaction data of the payment card may be used to know about the user preference about the shopping experience and verify the answer provided by the user to a password question. Relevant data such as merchant category code or merchant name can be extracted from the transaction data to identify a pattern, and the user may be asked to rate experience of using physical store X, blog shop Y, Amazon, Barnes & Nobles, etc.

According to various embodiments, in a first step, a user preference database is created when a user registers for this service at a server, for example Mastercard® server. The server may look into the user transaction history and may list down top 5 cities from where the transaction was initiated. It may also identify top 5 transaction categories. If the user wants to register for the auto generated questions, the server may ask for the user ID (UID) of different online shopping portals (like Amazon, Flipkart and Snapdeal etc.) which the user preferred generally, so that the server may track the user's feedback of the last purchased item from online shopping portal. It is to be noted that the server does not need the user's password of any online shopping portal, because any user can view the feedback of other users. Only the user ID may be required in order to identify the user on that portal.

The above inputs may help to determine preference attributes that would be most relevant or meaningful, to be presented to the user. As further described herein, these inputs may also be used to build a comprehensive preference profile of the user, such that if the user has multiple preferences for a category depending on his circumstance, the relevant matching preference is retrieved from the database when checking an answer to a password question.

### Terms Description (in Addition to Plain and Dictionary Meaning of Terms)

As used herein, the term “preference” means a liking for something over another. Preference can be expressed in various ways including but not limited to absolute terms (e.g. Yes/No, Like/Dislike), relative terms (e.g. More/Less), a ranked sequence or order (e.g. 1-2-3-4-5), a statement (e.g. “I like soup with a sprinkle of pepper”).

As used herein, the term “circumstantial” pertains to the condition, detail or state of the user, including but not limited to the time and place of the user, weather experienced by the user, financial status of the user, health condition of the user. It is appreciated that the circumstance of the user may change over time and the user's preference may change accordingly.

### Example Embodiments

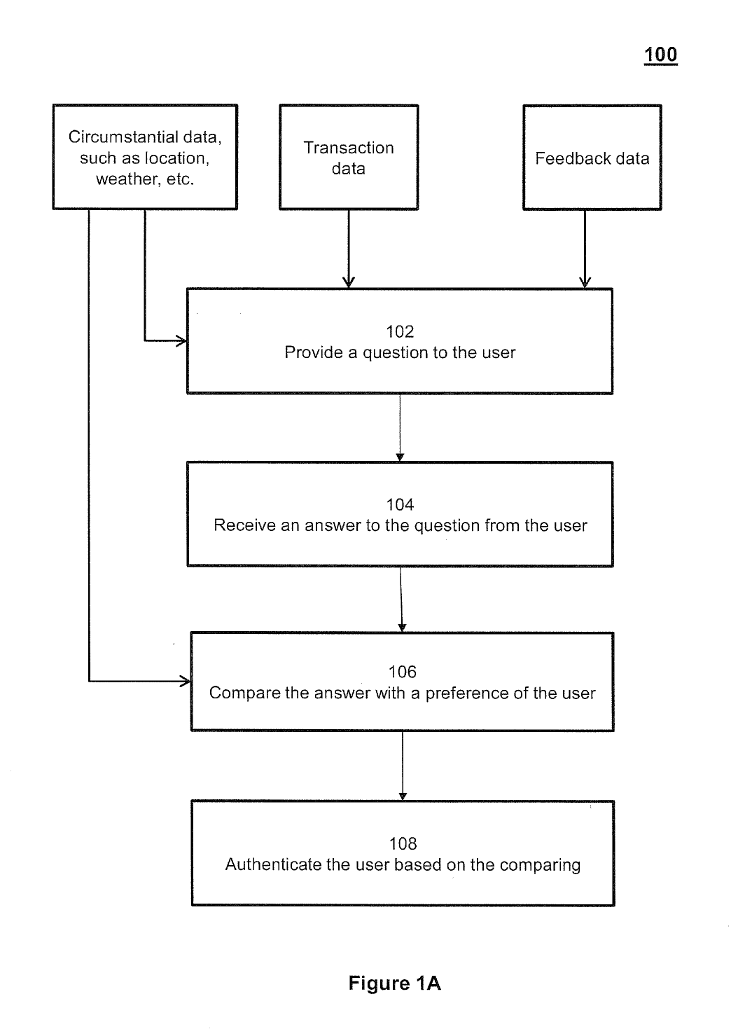

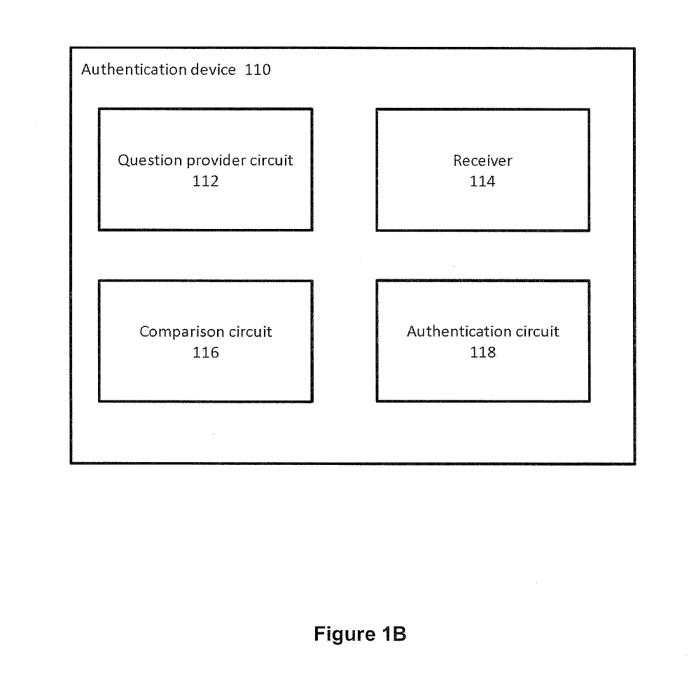

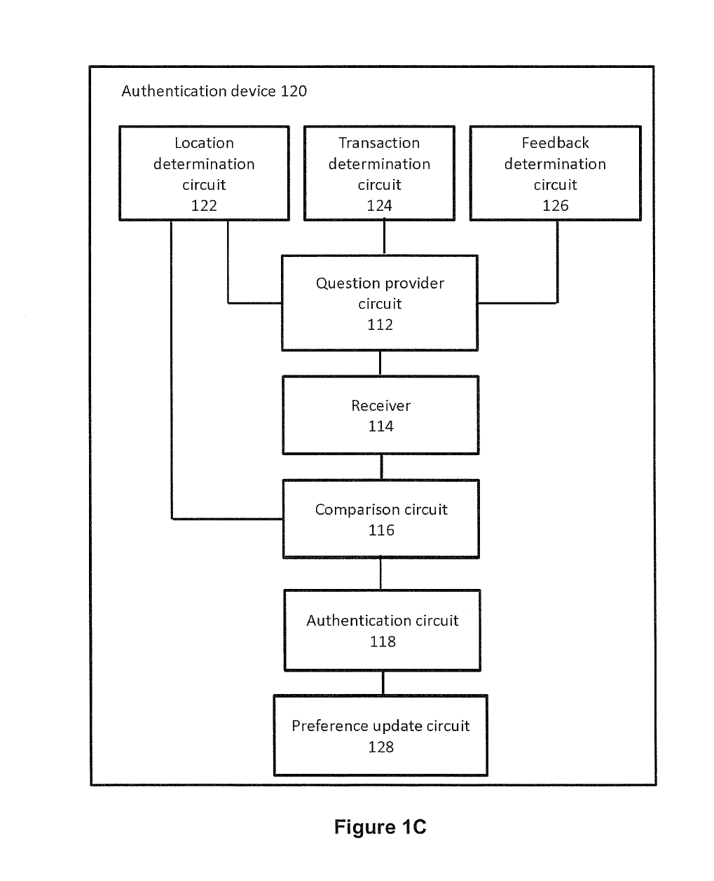

FIG. 1A shows a flow diagram 100 illustrating a method for authenticating a user according to various embodiments. In 102, a question may be provided to the user. In 104, an answer to the question may be received from the user. In 106, the answer may be compared with a preference of the user. In 108, the user may be authenticated based on the comparing. At least one of the question and the preference may be determined based on at least one of circumstantial data of the user, transaction data associated with the user, and feedback data from the user.

An example implementation of the method of FIG. 1A is now described. In this example, a user visits a website or launches an application using which the user can make a transaction or to perform a workflow. An initial log-on using e.g. password, PIN, biometric data, etc. may be required to access the features of the website or application. The transaction may be an online purchase, a funds transfer, a loan, etc.

If the transaction is a high value transaction, the website or application may prompt the user to provide additional authentication by way of a behavioural password. This may also be referred to as second-factor authentication. At step 102, the website of application provides a question to the user. The question may be determined based on at least one of circumstantial data of the user, transaction data associated with the user, and feedback data from the user. For example, based on transaction data indicating more spending on a category, a question relating to that category may be selected, such that it is more likely that the user may remember his preference in that category. After a relevant question has been determined, the question may be provided visually and/or audibly to the user. At step 104, an answer to the question may be received from the user via at least one of the input means, e.g. a keyboard, a mouse, a touch panel, a microphone, a joystick, etc.

The circumstantial data may be obtained from a user device (e.g. a smartphone) carried by the user, including but not limited to a location of the user, a weather at the location of the user, and a time at the location of the user. For example, location of the user may be determined from GPS data of the user device. The transaction data may be obtained from a database maintained by a financial institution or a payment card network, including but not limited to a payment card transaction, a bank account transaction, and a purchase transaction made by the user. The feedback data may be obtained by looking up for online contents having a username provided by the user, e.g. a comment authored by the user on an electronic commerce platform or a discussion forum.

At step 106, the answer is compared with a preference of the user. To make the comparison, a server running at the back-end of the website or application may, based on the circumstantial data of the user, select a relevant matching preference from one or more preferences associated with the user that are stored in a database. For example, if the question relates to a preference for food and the user has multiple preferences depending on his location, the location data can be used to retrieve the most relevant preference for the comparison with the answer from the user.

At step 108, the user is authenticated based on the result of the comparison in step 106. For example, if the answer matches with the preference of the user, the server at the back-end can inform the website or application accordingly, and the user's request for the transaction may be allowed to proceed. A confirmation message may be provided to the user, e.g. visually or audibly.

It will be appreciated that, for better security, a plurality of questions may be provided to the user. The plurality of questions may relate to different categories in order to thwart an attempt by an impostor who may have learned of the user's preferences in one category. According to various embodiments, a user may be authenticated if it is determined that at least a predetermined portion of answers to the plurality of questions matches preferences of the user. For example, the predetermined portion may be 80%, 90% or 95%. Different thresholds may be set depending on the value of the transaction or sensitivity of the data to be accessed following the authentication, such that a balance between security and convenience for the user may be achieved.

Moreover, the present method can update existing preferences of the user, as it is recognized that these preferences may change over time. According to various embodiments, the method may further include updating preferences of the user for questions for which the answers did not match the preferences of the user, if it is determined that at least a predetermined portion of answers to the plurality of questions matches preferences of the user. In other words, once the user has been authenticated as genuine, some of the user preferences may be updated if necessary. Updating a preference may include replacing that preference or adding a new preference. For example, it the location of the user has changed (i.e. the user has relocated), a new preference linked to the current location of the user may be created. Updated preferences are stored in a database accessible by the server.

FIG. 1B shows an authentication device 110 according to an example embodiment. For example, the authentication device 110 may be implemented as a server maintained by a financial institution or payment card network that controls the website that the user visits or the application that the user activates to perform a transaction. The authentication device 110 may include a question provider circuit 112 configured to provide a question to a user. The question may be determined based on at least one of circumstantial data of the user, transaction data associated with the user, and feedback data from the user. The authentication device 110 may further include a receiver 114 configured to receive an answer to the question from the user. The authentication device 110 may further include a comparison circuit 116 configured to compare the answer with a preference of the user. The preference may be selected, based on the circumstantial data of the user, from one or more stored preferences associated with the user. The authentication device 110 may further include an authentication circuit 118 configured to authenticate the user based on the comparing.

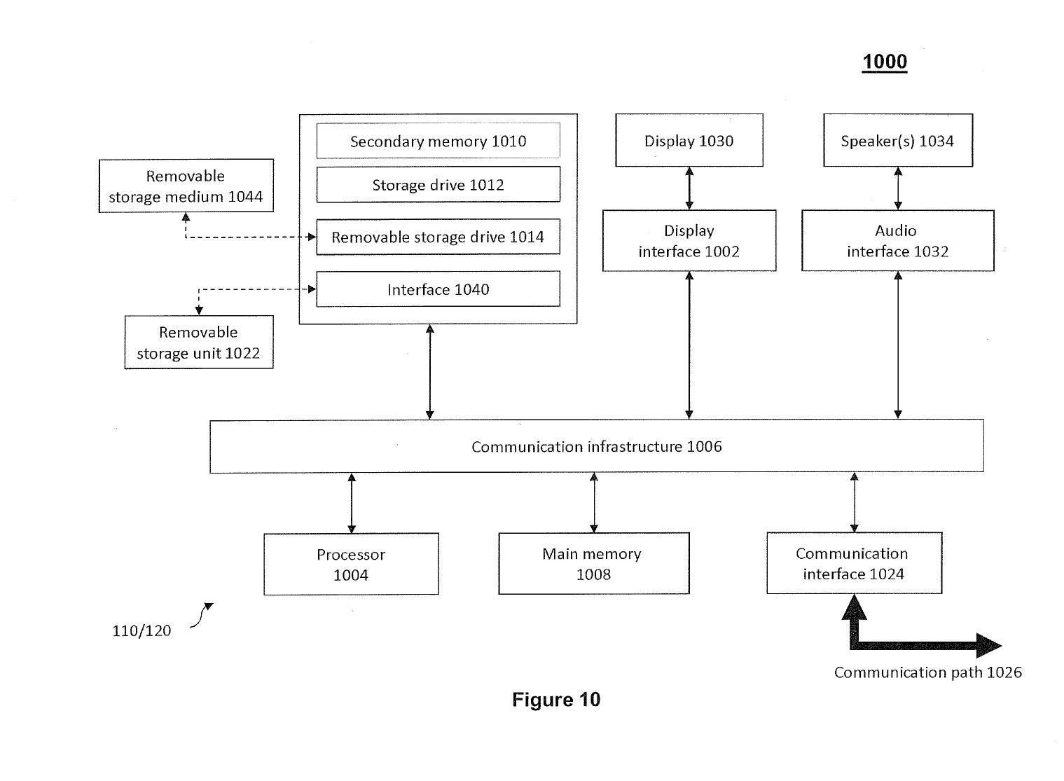

FIG. 10 shows an authentication device 120 implementing the structure of the authentication device 110 of FIG. 1B, including the question provider circuit 112, receiver 114, comparison circuit 116 and authentication circuit 118 as described above with reference to FIG. 1B. The authentication device 120 may further include a location determination circuit 122 configured to determine circumstantial data of the user, e.g. in the form of at least one of a location of the user, a weather at the location of the user, and a time at the location of the user. The location of the user can be determined, for example, from GPS data of a device carried by the user, and the weather and time can be determined accordingly once the location is known. The authentication device 120 may further include a transaction determination circuit 124 configured to determine transaction data associated with the user, e.g. in the form of at least one of a payment card transaction, a bank account transaction, and a purchase transaction made by the user. The authentication device 120 may further include a feedback determination circuit 126 configured to determine feedback data from the user, e.g. in the form of a comment authored by the user on an electronic commerce platform.

According to various embodiments, the question provider circuit 112 may be configured to provide a plurality of questions to the user. The authentication circuit 118 may be configured to authenticate the user if it is determined that at least a predetermined portion of answers to the plurality of questions matches preferences of the user.

Further, the authentication device 120 may include a preference update circuit 128 configured to update preferences of the user for questions for which the answers did not match the preferences of the user, if it is determined that at least a predetermined portion of answers to the plurality of questions matches preferences of the user.

The present method may also be implemented on a computer readable medium. The computer readable medium may include instructions which, when executed by a processor, make the processor perform the method for authenticating a user as described above.

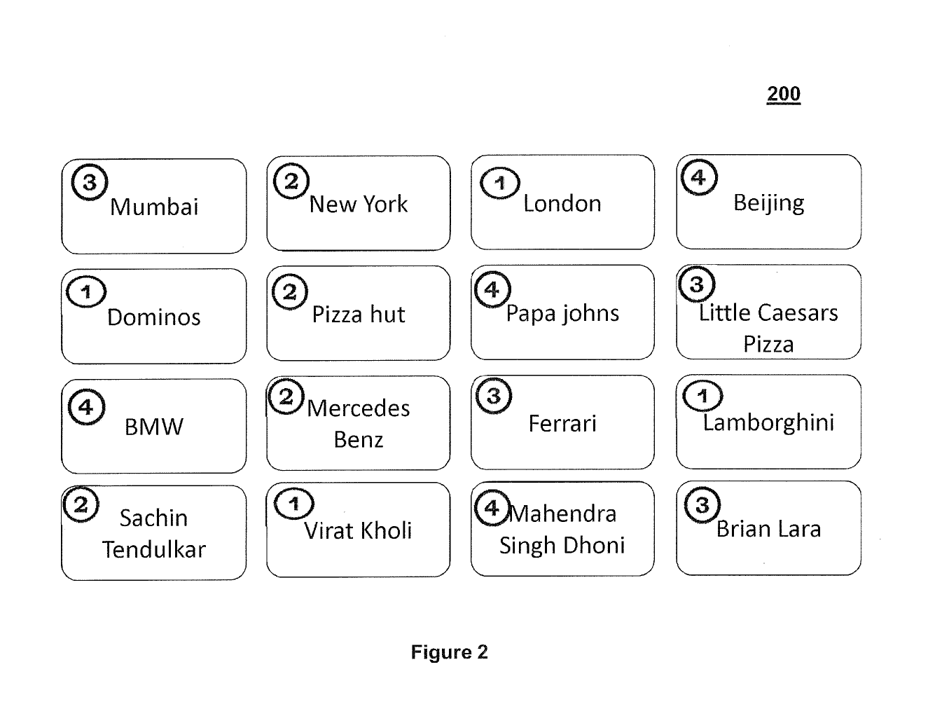

FIG. 2 shows an illustration 200 of possible questions, wherein a user may be asked to arrange the things shown based on the user's preference. In this example, each question is presented in a separate row, and each row may relate to a respective category. For example, the first row relates to cities, the second row relates to food chains, the third row relates to car makes and the fourth row relates to personalities. For each row, the user may select his preference order and an indicator, e.g. in a form of numbers, may be provided. For example, number 1 indicates most preferred and number 4 indicates least preferred.

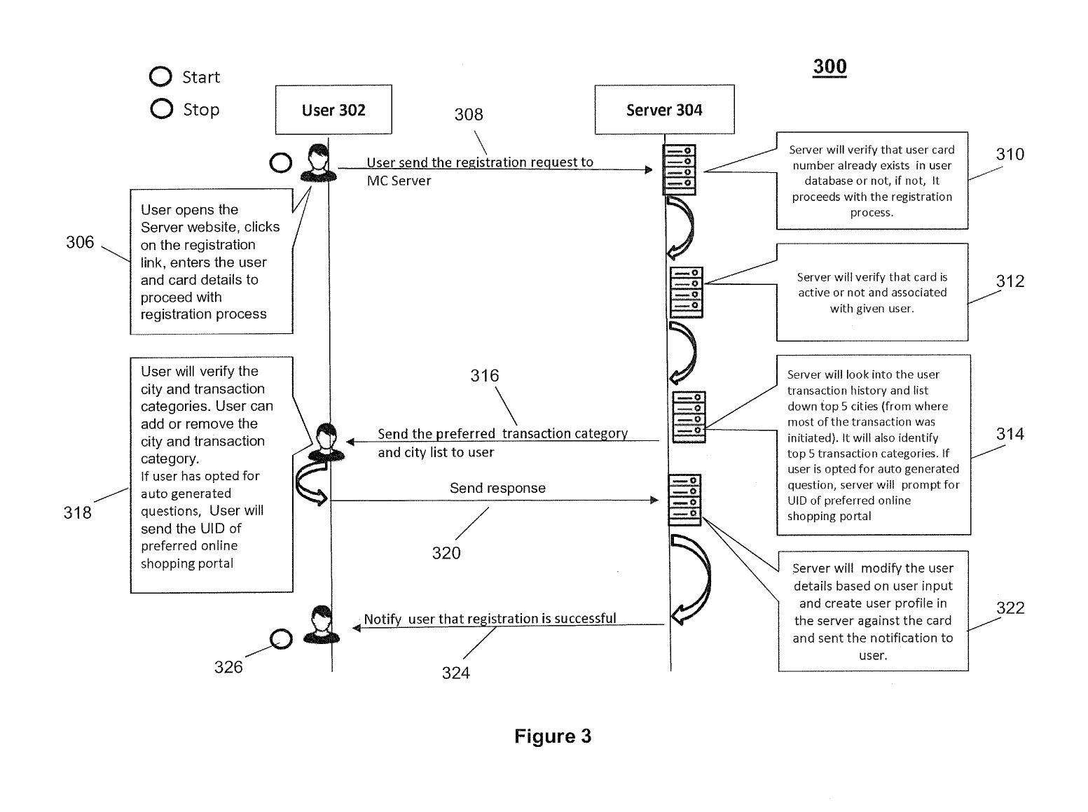

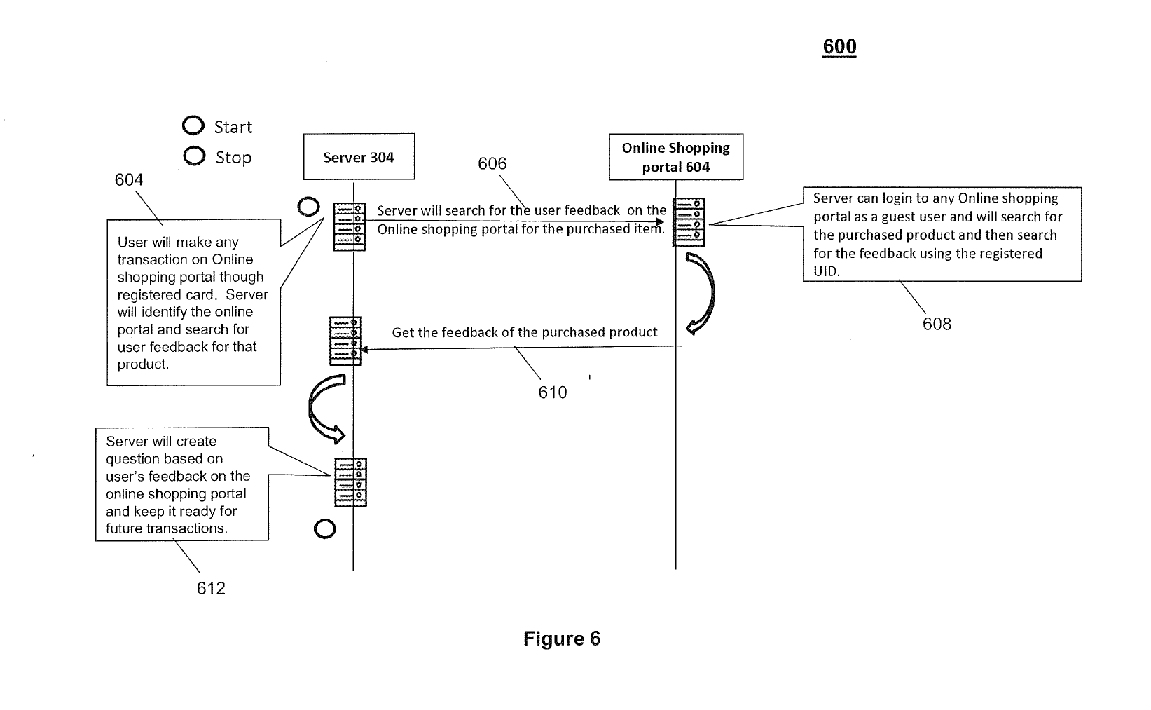

The present method and system may be implemented in a customer to business context (as described below with reference to FIGS. 3 to 5), or a business to business context (as described below with reference to FIGS. 6 to 9).

FIG. 3 shows a flow diagram 300 illustrating a dataflow for user registration, when a user 302 is directly registered for this service (for example in a customer to business context) with a server 304, for example a Mastercard® server, according to various embodiments. For example, the user may visit a website or portal or launch an application controlled by the server.

Processing may start in 306, when the user 302 opens the server website (for example Mastercard® website), and clicks on a registration link. The user 302 may enter user details and card details to proceed with registration process. In 308, the user 302 may send the registration request to the server 304. In 310, the server 304 may verify whether the user's card number already exists in user database or not, and if not, the server 304 may proceed with the registration process. In 312, the server 304 may verify whether the card is active or not and associated with the given user 302. In 314, the server 304 may look into the user transaction history and list down preferential data, for example top 5 cities (for example, from where most of the transaction was initiated), and may also identify top 5 transaction categories. If the user 302 has opted for auto generated questions, the server 304 may prompt for UID (user identifier) of preferred online shopping portals. In 316, the server 304 may send the preferential data, for example preferred transaction categories and city list, to the user 302. In 318, the user 302 may verify the preferential data (for example city and transaction categories). The user 302 may add or remove data from the preferential data. If the user 302 has opted for auto generated questions, the user may send the UID of preferred online shopping portal in 320. In 322, the server 304 may modify the user details based on user input and may create a user profile in the server 304 against the card and send the notification to user. In 324, the server 324 may send the notification to notify the user 302 that the registration is successful. Processing may end in 326.

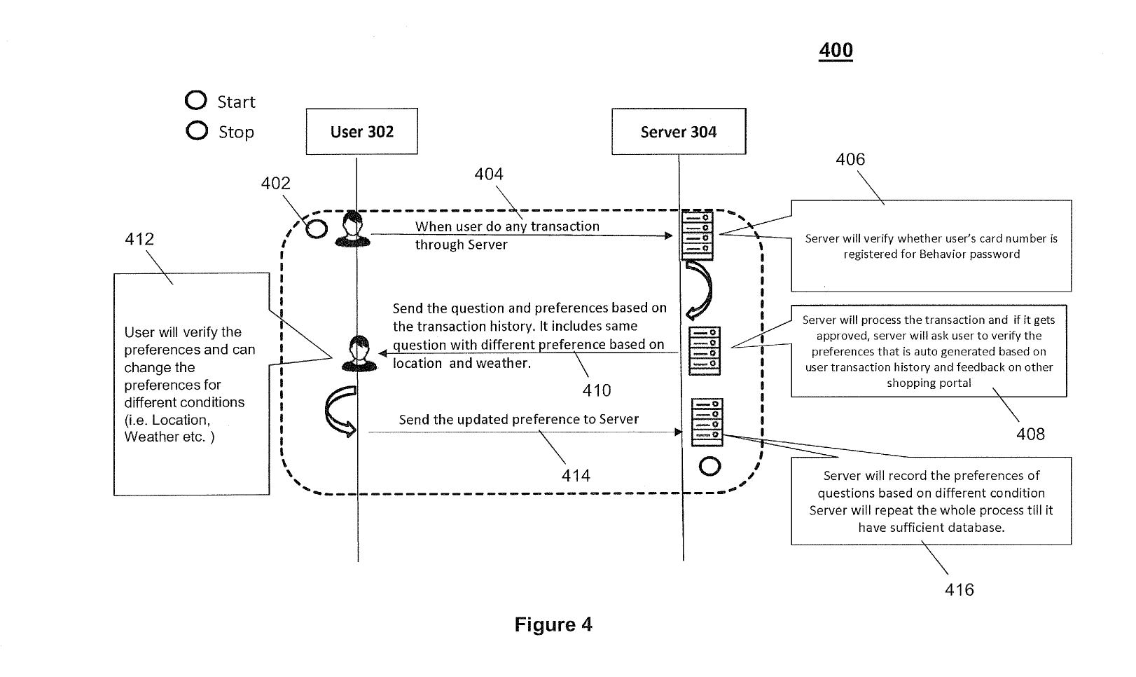

FIG. 4 shows a flow diagram 400 illustrating dataflow to create a user preference database, when the user 302 is directly registered for this service (for example in a customer to business context) according to various embodiments. In 402, processing may start. In 404, the user may do any transaction through the server 304. In 406, the server 304 may verify whether the user's card number is registered for behavior password. In 408, the server 304 may process the transaction and if it got approved, the server 304 may ask the user 302 to verify the preferences that are auto generated, for example based on user transaction history and feedback on a shopping portal. In 410, the server 304 may send the question and preferences, for example based on the transaction history. The question may include a same question with different preferences based on location and/or weather. In 412, the user 302 may verify the preferences and may change the preferences for different conditions (for example location, climate, time, and/or weather). In 414, the user 302 may send the updated preferences to the server 304. In 416, the server 304 may record the preferences of questions based on a different condition, and the server 304 may repeat the whole process until the server 304 has a sufficient database, so that processing may then end.

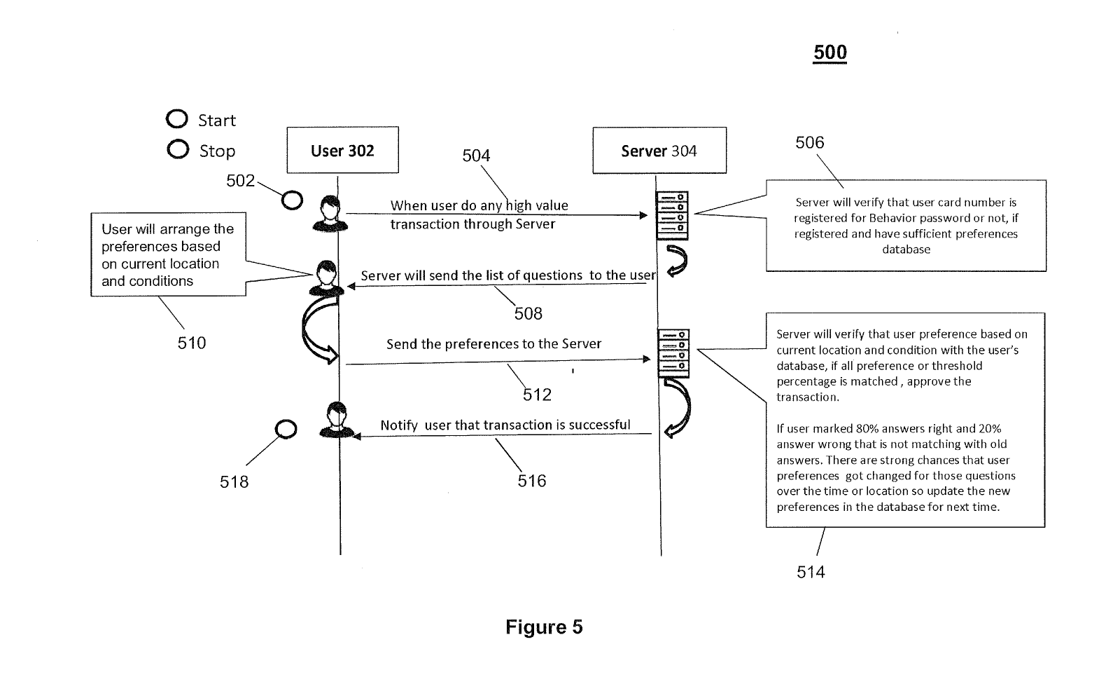

FIG. 5 shows a flow diagram 500 illustrating a dataflow to verify a user preference database, when the user 302 is directly registered for this service (for example in a customer to business context) according to various embodiments. In 502, processing may start. In 504, the user 302 may do any high value transaction through the server 304. In 506, the server 304 may verify whether the user card number is registered for behavior password or not, and if registered, whether there is a sufficiently large preferences database. In 508, the server 304 may send the list of questions to the user 302. In 510, the user 302 may arrange the preferences based on current location and conditions. In 512, the user 302 may send the preferences to the server 304. In 514, the server 304 may verify the user preference based on current location and condition with the user's database, and if all preference or a threshold percentage is matched, approve the transaction. If user marked a certain portion (for example 80%) of the answers right and another portion (for example 20%) of the answers wrong (i.e. not matching with old answers), there may be strong chances that user preferences got changed for those questions over the time or location so that the server 304 may update the new preferences in the database for next time. In 516, the server 304 may notify the user 302 that the transaction is successful. Processing may end in 518.

FIG. 6 shows a flow diagram 600 illustrating dataflow between the server 304 and an online shopping portal 602 (for example in a business to business context) according to various embodiments. Processing may start in 604, where the user may make any transaction on an online shopping portal though a registered card. The server 304 may identify the online portal and may search for user feedback for that product. In 606, the server 304 may search for the user feedback on the online shopping portal 602 for the purchased item. In 608, the server 304 may login to any online shopping portal 602 as a guest user and may search for the purchased product and then search for the feedback using the registered UID. In 610, the server 304 may get the feedback on the purchased product from the online shopping portal 602. In 612, the server 304 may create a question based on user's feedback on the online shopping portal and may keep it ready for future transactions, and processing may end.

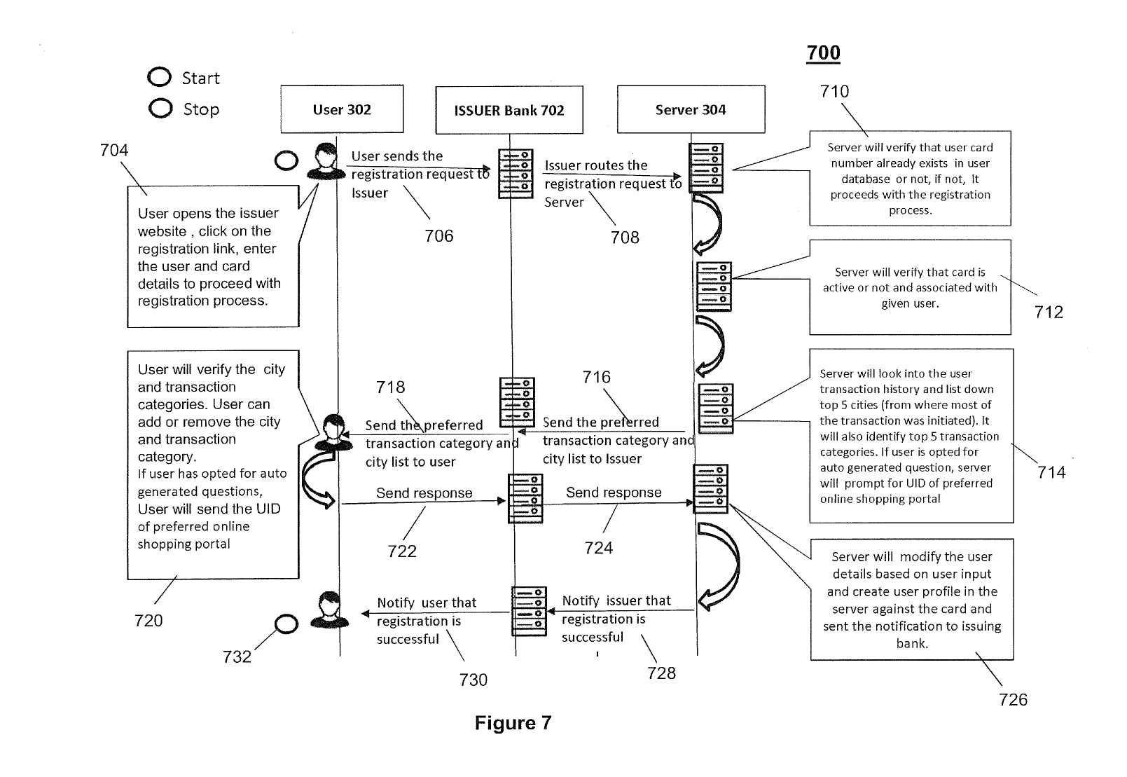

FIG. 7 shows a flow diagram 700 illustrating a dataflow for user registration, when a member bank (in other words: issuer bank 702) wants to register its user 302 for behavior password service (for example in a business to business context) according to various embodiments. In 704, processing may start, and the user 302 may open the website of the user bank 702 (in other words: the issuer website), and click on the registration link, enter the user details and card details to proceed with registration process. In 706, the user 302 may send the registration request to the issuer bank 702. In 708, the issuer bank 702 may route the registration request to the server 304. In 710, the server 304 may verify whether the user card number already exists in a user database or not, and if not, the server 304 may proceed with the registration process. In 712, the server 304 may verify whether the card is active or not and whether it is associated with the given user 302. In 714, the server 304 may look into the user transaction history and may determine preferential data (for example a list of top 5 cities, from where most of the transaction was initiated, and/or top 5 transaction categories). If the user 302 is opted for auto generated question, the server 304 may prompt for UID of preferred online shopping portal. In 716, the server 304 may send the preferential data (for example preferred transaction category and city list) to the issuer bank 702. In 718, the issuer bank 702 may send the preferential data (for example preferred transaction category and city list) to the user 302. In 720, the user 302 may verify the preferential data (for example city and transaction categories). The user 302 may add or remove preferential data (for example the city and transaction category). If the user 302 has opted for auto generated questions, the user 302 may send the UID of preferred online shopping portal (for example via the issuer bank 702 to the server 304, like illustrated in 722 and 724). In 726, the server 304 may modify the user details based on user input and may create a user profile in the server 304 against the card and sent the notification to issuing bank. In 728, the server 304 may notify the issuer bank 702 that registration is successful. In 730, the issuer bank 702 may notify the user 302 that registration is successful. Processing may end in 732.

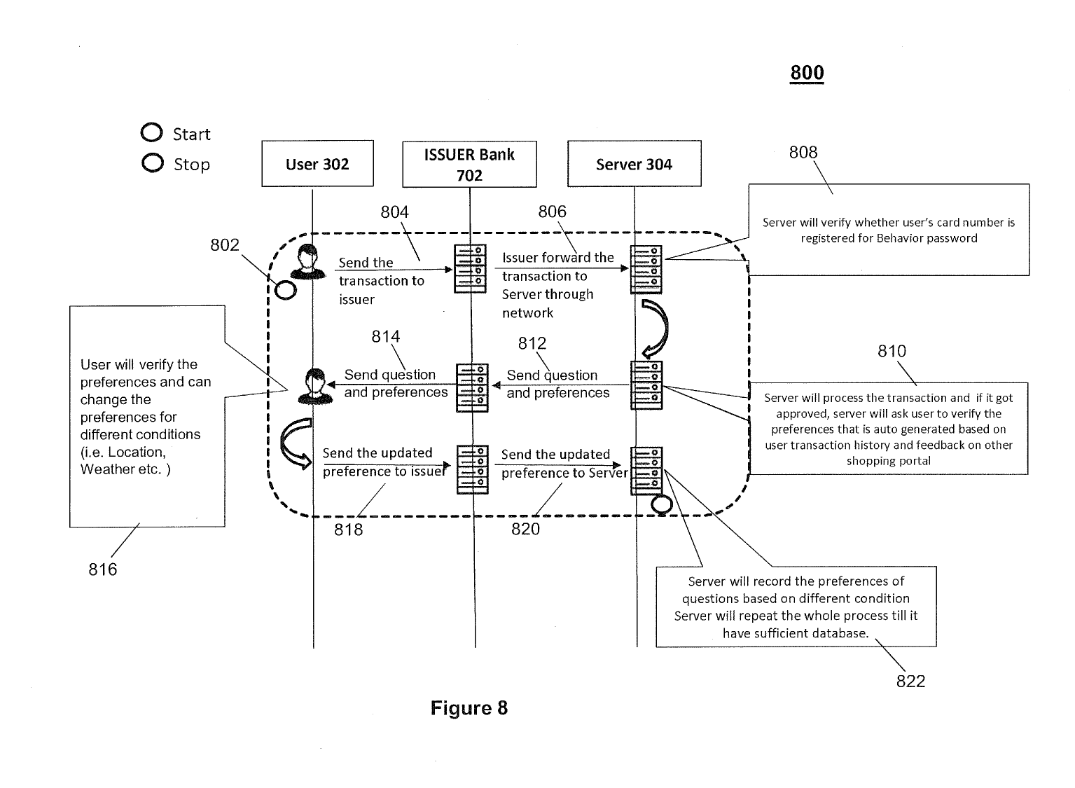

FIG. 8 shows a flow diagram 800 illustrating a dataflow to create a user preference database, when a user's Issuer (for example issuer bank 702) is registered for behavior password service (for example in a business to business context) according to various embodiments. Processing may start in 802. In 804, the user 302 may send the transaction to the issuer bank 702. In 806, the issuer bank 702 may forward the transaction to the server 304 (for example through a network belonging to the operator of the server, for example through a Mastercard® network). In 808, the server 304 may verify whether the user's card number is registered for behavior password. In 810, the server 304 may process the transaction and if it got approved, the server 304 may ask the user 302 to verify the preference that is auto generated based on user transaction history and feedback on other shopping portal. Like illustrated in 812 and 814, the question and the preferences to may be sent to the user 302 through the issuer network, and the question and the preferences may be based on the transaction history. The question may be a same question with different preferences based on for example location and/or weather. In 816, the user 302 may verify the preferences and may change the preferences for different conditions (i.e. location, weather etc.). In 818, the user 302 may send the updated preference to the issuer bank 702. In 820, the issuer bank 702 may send the updated preference to the server 304. In 822, the server 304 may record the preferences of questions based on different conditions, and the server 304 may repeat the whole process till it have sufficient database, so that then processing may end.

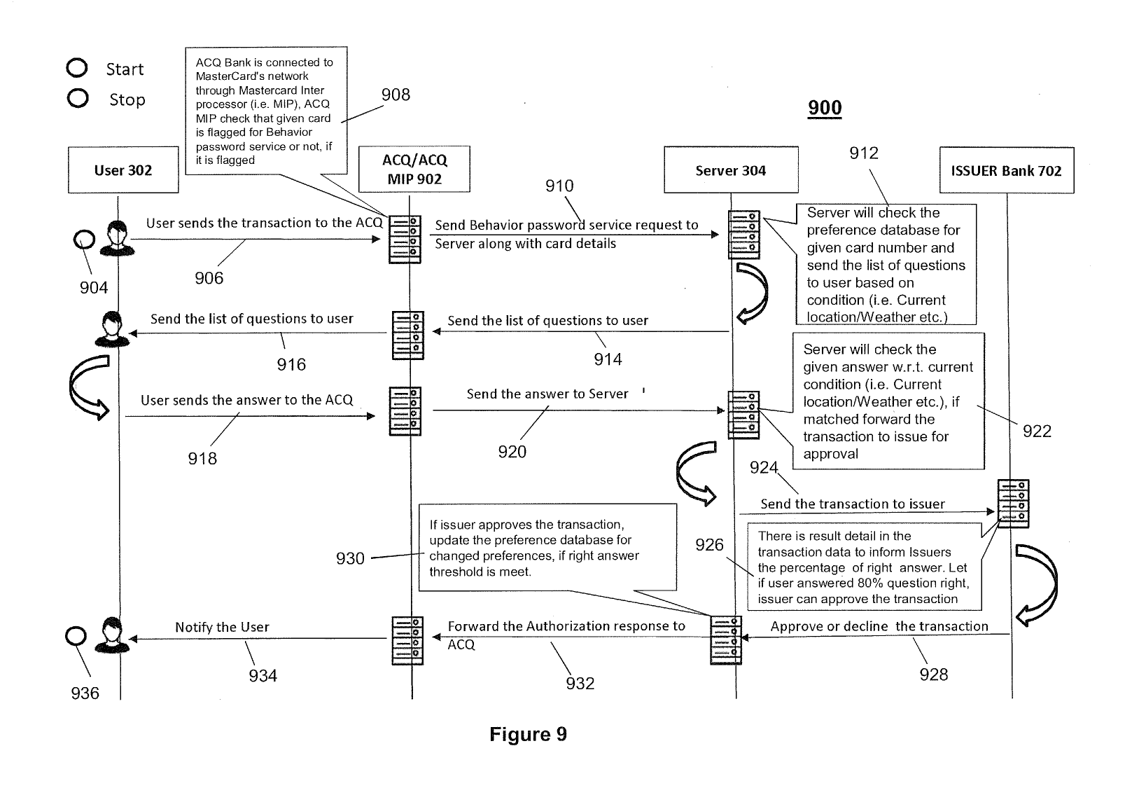

FIG. 9 shows a flow diagram 900 illustrating a dataflow between the server 304 and the member bank (in other words: issuer bank 702), when the user's issuer is registered for behavior password service (for example in a business to business context) according to various embodiments. Processing may start in 904. In 906, the user 302 may send the transaction to the ACQ 902 (acquirer; in other words: ACQ (acquirer) bank 902). Like illustrated by 908, the ACQ bank may be connected to a network, for example connected to MasterCard®'s network through Mastercard® Inter processor (i.e. MIP, or any other inter processor device like described below), and the ACQ MIP may check whether the given card is flagged for behavior password service or not, and if it is flagged, in 910, may send a behavior password service request to the server 304 along with card details. An inter processor device is an edge device in which a communication processor is placed at a customer site for Acquirers/Issuers/Processors to access a credit card network. Acquirer (ACQ) inter process device is an edge device which receive the transaction from acquirer host. In 912, the server 304 may check the preference database for given card number and may send the list of questions to user 302 based on condition (for example based on current location/weather etc.). In 914 and 916, the server 304 may send the list of questions to the user 302 (for example via the ACQ/ACP MIP 902). In 918, the user 302 may send the answer to the ACQ 902. In 920, the ACQ 902 may send the answer to the server 304. In 922, the server 304 may check the given answer with respect to a current condition (for example current location and/or current weather), and if matched, may forward the transaction to issuer bank 702 for approval. In 924, the server 304 may send the transaction to the issuer bank 702. In 926, there may be provided result details in the transaction data to inform the issuer bank 702 of the percentage of right answers. If the user answered at least a pre-determined portion (for example 80%) of the questions right, the issuer bank 702 may approve the transaction. In 928, the issuer bank 702 may approve or decline the transaction. In 930, if the issuer bank 702 approves the transaction, the server 304 may update the preference database for changed preferences, if right answer threshold is met. In 932, the server 304 may forward the authorization response to the ACQ 902. In 934, the ACQ may notify the user 302. Processing may end in 936.

FIG. 10 depicts an exemplary computing device 1000, hereinafter interchangeably referred to as a computer system 1000 or as a server 1000, where one or more such computing devices 1000 may be used to implement the authentication device 110 shown in FIG. 1B or the authentication device 120 shown in FIG. 1C. The following description of the computing device 1000 is provided by way of example only and is not intended to be limiting.

As shown in FIG. 10, the example computing device 1000 includes a processor 1004 for executing software routines. Although a single processor is shown for the sake of clarity, the computing device 1000 may also include a multi-processor system. The processor 1004 is connected to a communication infrastructure 1006 for communication with other components of the computing device 1000. The communication infrastructure 1006 may include, for example, a communications bus, cross-bar, or network.

The computing device 1000 further includes a main memory 1008, such as a random access memory (RAM), and a secondary memory 1010. The secondary memory 1010 may include, for example, a storage drive 1012, which may be a hard disk drive, a solid state drive or a hybrid drive and/or a removable storage drive 1014, which may include a magnetic tape drive, an optical disk drive, a solid state storage drive (such as a USB flash drive, a flash memory device, a solid state drive or a memory card), or the like. The removable storage drive 1014 reads from and/or writes to a removable storage medium 1044 in a well-known manner. The removable storage medium 1044 may include magnetic tape, optical disk, non-volatile memory storage medium, or the like, which is read by and written to by removable storage drive 1014. As will be appreciated by persons skilled in the relevant art(s), the removable storage medium 1044 includes a computer readable storage medium having stored therein computer executable program code instructions and/or data.

In an alternative implementation, the secondary memory 1010 may additionally or alternatively include other similar means for allowing computer programs or other instructions to be loaded into the computing device 1000. Such means can include, for example, a removable storage unit 1022 and an interface 1050. Examples of a removable storage unit 1022 and interface 1050 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 1022 and interfaces 1050 which allow software and data to be transferred from the removable storage unit 1022 to the computer system 1000.

The computing device 1000 also includes at least one communication interface 1024. The communication interface 1024 allows software and data to be transferred between computing device 1000 and external devices via a communication path 1026. In various embodiments of the inventions, the communication interface 1024 permits data to be transferred between the computing device 1000 and a data communication network, such as a public data or private data communication network. The communication interface 1024 may be used to exchange data between different computing devices 1000 which such computing devices 1000 form part an interconnected computer network. Examples of a communication interface 1024 can include a modem, a network interface (such as an Ethernet card), a communication port (such as a serial, parallel, printer, GP IB, IEEE 1394, RJ45, USB), an antenna with associated circuitry and the like. The communication interface 1024 may be wired or may be wireless. Software and data transferred via the communication interface 1024 are in the form of signals which can be electronic, electromagnetic, optical or other signals capable of being received by communication interface 1024. These signals are provided to the communication interface via the communication path 1026.

As shown in FIG. 10, the computing device 1000 further includes a display interface 1002 which performs operations for rendering images to an associated display 1030 and an audio interface 1032 for performing operations for playing audio content via associated speaker(s) 1034.

As used herein, the term “computer program product” (or computer readable medium, which may be a non-transitory computer readable medium) may refer, in part, to removable storage medium 1044, removable storage unit 1022, a hard disk installed in storage drive 1012, or a carrier wave carrying software over communication path 1026 (wireless link or cable) to communication interface 1024. Computer readable storage media (or computer readable media) refers to any non-transitory, non-volatile tangible storage medium that provides recorded instructions and/or data to the computing device 1000 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 1000. Examples of transitory or non-tangible computer readable transmission media that may also participate in the provision of software, application programs, instructions and/or data to the computing device 1000 include radio or infra-red transmission channels as well as a network connection to another computer or networked device, and the Internet or Intranets including e-mail transmissions and information recorded on Websites and the like.

The computer programs (also called computer program code) are stored in main memory 1008 and/or secondary memory 1010. Computer programs can also be received via the communication interface 1024. Such computer programs, when executed, enable the computing device 1000 to perform one or more features of embodiments discussed herein. In various embodiments, the computer programs, when executed, enable the processor 1004 to perform features of the above-described embodiments. Accordingly, such computer programs represent controllers of the computer system 1000.

Software may be stored in a computer program product and loaded into the computing device 1000 using the removable storage drive 1014, the storage drive 1012, or the interface 1050. The computer program product may be a non-transitory computer readable medium. Alternatively, the computer program product may be downloaded to the computer system 1000 over the communications path 1026. The software, when executed by the processor 1004, causes the computing device 1000 to perform functions of embodiments described herein.

It is to be understood that the embodiment of FIG. 10 is presented merely by way of example. Therefore, in some embodiments one or more features of the computing device 1000 may be omitted. Also, in some embodiments, one or more features of the computing device 1000 may be combined together. Additionally, in some embodiments, one or more features of the computing device 1000 may be split into one or more component parts. The main memory 1008 and/or the secondary memory 1010 may serve(s) as the memory for authentication device 110 shown in FIG. 1B or the authentication device 120 shown in FIG. 1C; while the processor 1004 may serve as the processor of the authentication device 110 shown in FIG. 1B or the authentication device 120 shown in FIG. 1C.

Some portions of the description herein are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the description herein, it will be appreciated that throughout the present specification, discussions utilizing terms such as “receiving”, “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer suitable for executing the various methods/processes described herein will appear from the description herein.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

According to various embodiments, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit” in accordance with an alternative embodiment.

It will be understood that functionality of one or more circuits may be combined in a single circuit or split up into several circuits.

Various features are described for a device, but may analogously also be provided for a method, and vice versa.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A method for authenticating a user, the method comprising:
providing a question to the user;
receiving an answer to the question from the user;
comparing the answer with a preference of the user; and
authenticating the user based on the comparing;
wherein at least one of the question and the preference is determined based on at least one of circumstantial data of the user, transaction data associated with the user, and feedback data from the user.

2. The method of claim 1, further comprising:
determining at least one of a location of the user, a weather at the location of the user, and a time at the location of the user.

3. The method of claim 2,
wherein the circumstantial data comprise at least one of the location, the weather, and the time.

4. The method of claim 1, further comprising:
determining at least one of a payment card transaction, a bank account transaction, and a purchase transaction made by the user.

5. The method of claim 4,
wherein the transaction data associated with the user comprise at least one of the payment card transaction, the bank account transaction, and the purchase transaction made by the user.

6. The method of claim 1, further comprising:
determining a comment authored by the user on an electronic commerce platform.

7. The method of claim 6,
wherein the feedback data from the user comprise the comment.
wherein a plurality of questions are provided to the user; and
wherein a user is authenticated if it is determined that at least a predetermined portion of answers to the plurality of questions matches preferences of the user.

9. The method of claim 8, further comprising:
updating preferences of the user for questions for which the answers did not match the preferences of the user, if it is determined that at least a predetermined portion of answers to the plurality of questions matches preferences of the user.

10. An authentication device comprising:
a question provider circuit configured to provide a question to a user based on at least one of circumstantial data of the user, transaction data associated with the user, and feedback data from the user;
a receiver configured to receive an answer to the question from the user;
a comparison circuit configured to compare the answer with a preference of the user; and
an authentication circuit configured to authenticate the user based on an output from the comparison circuit;
wherein the preference is selected, based on the circumstantial data of the user, from one or more stored preferences associated with the user.

11. The authentication device of claim 10, further comprising:
a location determination circuit configured to determine at least one of a location of the user, a weather at the location of the user, and a time at the location of the user.

12. The authentication device of claim 11,
wherein the circumstantial data comprise at least one of the location, the weather, and the time.

13. The authentication device of claim 10, further comprising:
a transaction determination circuit configured to determine at least one of a payment card transaction, a bank account transaction, and a purchase transaction made by the user.

14. The method of claim 13,
wherein the transaction data comprise at least one of the payment card transaction, the bank account transaction, and the purchase transaction made by the user.

15. The authentication device of claim 10, further comprising:
a feedback determination circuit configured to determine a comment authored by the user on an electronic commerce platform.

16. The authentication device of claim 15,
wherein the feedback data comprise the comment.

17. The authentication device of claim 10,
wherein the question provider circuit is configured to provide a plurality of questions to the user; and
wherein an authentication circuit is configured to authenticate the user if it is determined that at least a predetermined portion of answers to the plurality of questions matches preferences of the user.

18. The authentication device of claim 17, further comprising:
a preference update circuit configured to update preferences of the user for questions for which the answers did not match the preferences of the user, if it is determined that at least a predetermined portion of answers to the plurality of questions matches preferences of the user.

19. A computer readable medium comprising instructions which, when executed by a processor, make the processor perform a method for authenticating a user, the method comprising:
providing a question to the user;
receiving an answer to the question from the user;
comparing the answer with a preference of the user; and
authenticating the user based on the comparing;
wherein at least one of the question and the preference is determined based on at least one of circumstantial data of the user, transaction data associated with the user, and feedback data from the user.
